(19) United States
(12) Patent Application Publication
(10) Pub. No.: US 2009/0078685 A1
(43) Pub. Date: Mar. 26, 2009

(54) PLASMA HEAD AND PLASMA-DISCHARGING DEVICE USING THE SAME

(75) Inventors: Chen-Der TSAI, Hsinchu County (TW); Chih-Wei CHEN, Taipei County (TW); Chia-Chiang CHANG, Taipei County (TW); Wen-Tung HSU, Yunlin County (TW); Te-Hui YANG, Hsinchu City (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 12/061,082

(22) Filed: Apr. 2, 2008

(30) Foreign Application Priority Data
Sep. 21, 2007 (TW) 096135262

(51) Int. Cl. B23K 10/00

(52) U.S. Cl. 219/121.5; 219/121.48

(57) ABSTRACT

A plasma head and the plasma-discharging device using the same are disclosed. The plasma-discharging device comprises a power supply with two electrode terminals. The plasma head comprises: an outer electrode having a chamber formed therein; an inner electrode, disposed inside the chamber; and a flow guiding structure, disposed inside the inner electrode; wherein the outer electrode and the inner electrode are connected respectively to the two electrode terminals of the power supply; and the flow guiding structure further comprises at least an inlet for introducing a working fluid into the inner electrode and at least an outlet being communicated with the chamber of the outer electrode to guide the working fluid to flow into the chamber of the outer chamber. As the inner electrode can be cooled by the flowing working fluid, not only the wear and tear of the inner electrode can be avoided as its temperature is effective reduced, but also the lifetime of the inner electrode is prolonged and the contamination caused by ion stripping.

### BACKGROUND OF THE INVENTION

1. Field of the Invention

The present invention generally relates to a plasma head and a plasma-discharging device using the same and, more particularly, to a plasma head with an inner electrode having a cooling channel disposed therein for introducing a working fluid into the inner electrode as a cooling fluid and a plasma-discharging device using such a plasma head.

2. Description of the Prior Art

The atmospheric-pressure plasma is the plasma generated at around one atm. From a view point of equipment cost, costly and heavy vacuum equipments are not required. And, from a view point of processing, the work can be done uninterrupted and unlimited by the vacuum chamber. All this helps to effectively reduce the manufacturing cost.

The atmospheric-pressure plasma is generated by applying an electric field between two electrodes in an atmospheric pressure environment to cause the breakdown ionization of gaseous components. There are various plasma sources due to different formation principles of the plasma, which can be categorized into corona discharge, dielectric barrier discharge, plasma jet and plasma torch. During plasma operation, the inner electrode might be damaged due to the high input voltage and the extremely high-temperature of the plasma so that the lifetime of the inner electrode is limited and the ion of the electrode may stripping and thus caused contamination.

Moreover, in order to generate the plasma, an external energy is applied to continuously ionize neutral components. Therefore, there is required a large breakdown voltage depending on gas species, electrode intervals and operation pressures. Please refer to FIG. 1, which shows that the plasma is generated by applying an operation voltage as high as 1000 volts in an atmospheric pressure environment. As shown in FIG. 2, which shows the relation of the working pressure, the gas temperature Tg and the electron temperature Te. In a typical low-pressure environment, the probability for electrons and neutral atoms to collide within a mean free path is low and the energy cannot be effectively transferred. Meanwhile, the electron temperature Te is thousand of degrees Kelvin (or several electron volts, eV), while the gas temperature Tg is only hundreds of degrees Kelvin. The plasma generated thereby is referred to as the low-temperature plasma. As the pressure increases, the probability for electrons and neutral atoms to collide within a mean free path is raised, which causes the energy to be effectively transferred and achieves equilibrium. Meanwhile, the electron temperature Te and the gas temperature Tg tend to be equal. The plasma generated thereby is referred to as the thermal equilibrium plasma.

Accordingly, in order to obtain the atmospheric-pressure plasma, a high voltage is applied between two electrodes. Part of the electric energy can be transformed into thermal energy to increase the electrode temperature. Meanwhile, another source of thermal energy derives from generation of the plasma. The summed thermal energies heat up the electrodes, especially the inner electrode (also referred to as the anode). Therefore, in an atmospheric-pressure plasma system, the inner electrode is a consumable, which has to be replaced only after hundreds to thousands of hours of use. What is worse, the electrodes are consumed when the metal particles are stripped, which causes contamination.

In Taiwan Patent Application No. 095220778 “low-temperature plasma discharge device”, as shown in FIG. 3, a plasma discharge device 100 capable of generating plasma at a low temperature comprises an outer electrode 102 having a first chamber 101 and a second chamber 111. An inner electrode 106 is disposed inside the first chamber 101. An opening 103 is disposed on one end of the first chamber 101. An inlet 109 introduces a working gas 110 to generate plasma 121 by corona discharge between the inner electrode 106 and the outer electrode 102. The plasma 121 is ejected from the first chamber 101 through the opening 103. Cooling tubes 127 and 129 are disposed inside and on the sidewall of the first chamber 101, respectively, so as to cool down the outer electrode 102. Heat transfer fins 120 and 119 are disposed inside the second chamber 111 and the inner electrode 106, respectively. The second chamber 111 communicates with a heat exchanging device 125 so that cooling media 123 and 117 can be introduced to perform heat exchange to reduce the operation temperature and prolong the lifetime of the electrodes. However, for such a plasma discharge device, the cooling tubes 127, 129, the heat transfer fins 120, 119 and the heat exchanging device 125 are externally added to the existing plasma discharge device 100 and are separated from the inlet 109 for the working gas 110. All this makes the plasma discharge device heavy, complicated and costly.

### SUMMARY OF THE INVENTION

It is an object of the present invention to provide to a plasma head and a plasma-discharging device using such a plasma head, the plasma head comprises an inner electrode having a cooling channel disposed therein for introducing a working fluid into the inner electrode as a cooling fluid to effectively reduce the electrode temperature, prevent the inner electrode from consumption, prolong the lifetime of the inner electrode and avoid contamination due to ion stripping.

In order to achieve the foregoing object, the present invention provides a plasma head and a plasma-discharging device using the plasma head. The plasma-discharging device comprises a power supply with two electrode terminals. The plasma head comprises: an outer electrode having a chamber formed therein; an inner electrode, disposed inside the chamber; and a flow guiding structure, disposed inside the inner electrode; wherein the outer electrode and the inner electrode are connected respectively to the two electrode terminals of the power supply; and the flow guiding structure further comprises at least an inlet for introducing a working fluid into the inner electrode and at least an outlet being communicated with the chamber of the outer electrode to guide the working fluid to flow into the chamber of the outer chamber.

### BRIEF DESCRIPTION OF THE DRAWINGS

The objects, spirits and advantages of the several embodiments of the present invention will be readily understood by the accompanying drawings and detailed descriptions, wherein:

FIG. 1 shows the relation of the operation voltage and the pressure for generating plasma using different gases;

FIG. 2 shows the relation of the operation pressure and the gas temperature Tg and the electron temperature Te;

FIG. 3 is a structural diagram of a low-temperature plasma discharge device according to Taiwan Patent Appl. No. 095220778;

FIG. 4 is a structural diagram of a plasma head and a plasma-discharging device using such a plasma head according to a first embodiment of the present invention;

FIG. 5 is a structural diagram of a plasma head according to a second embodiment of the present invention;

FIG. 6 is a 3-dimensional structural diagram of a flow guiding unit in the plasma head according to a second embodiment of the present invention;

FIG. 7 is a structural diagram of a plasma head according to a third embodiment of the present invention;

FIG. 8 is a 3-dimensional structural diagram of a flow guiding unit in the plasma head according to a third embodiment of the present invention; and

FIG. 9 is a structural diagram of a plasma head according to a fourth embodiment of the present invention.

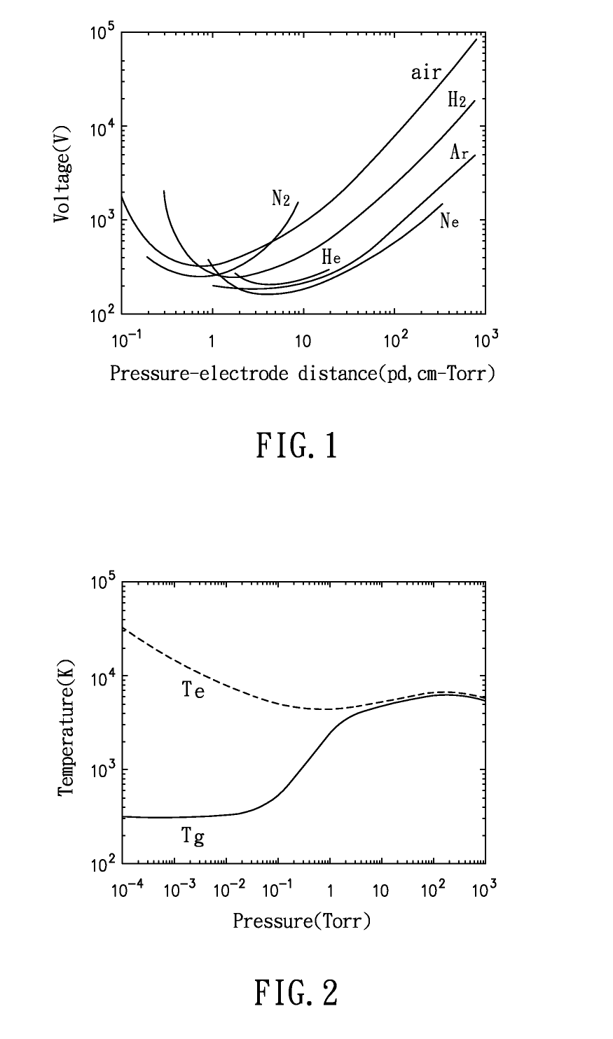

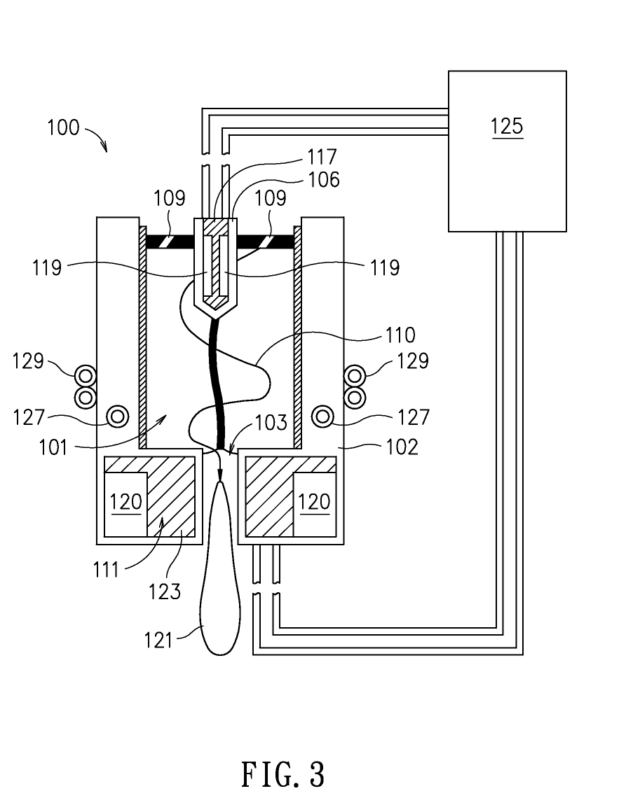

### DETAILED DESCRIPTION OF THE PREFERRED EMBODIMENT

The present invention can be exemplified by but not limited to the embodiments as described hereinafter.

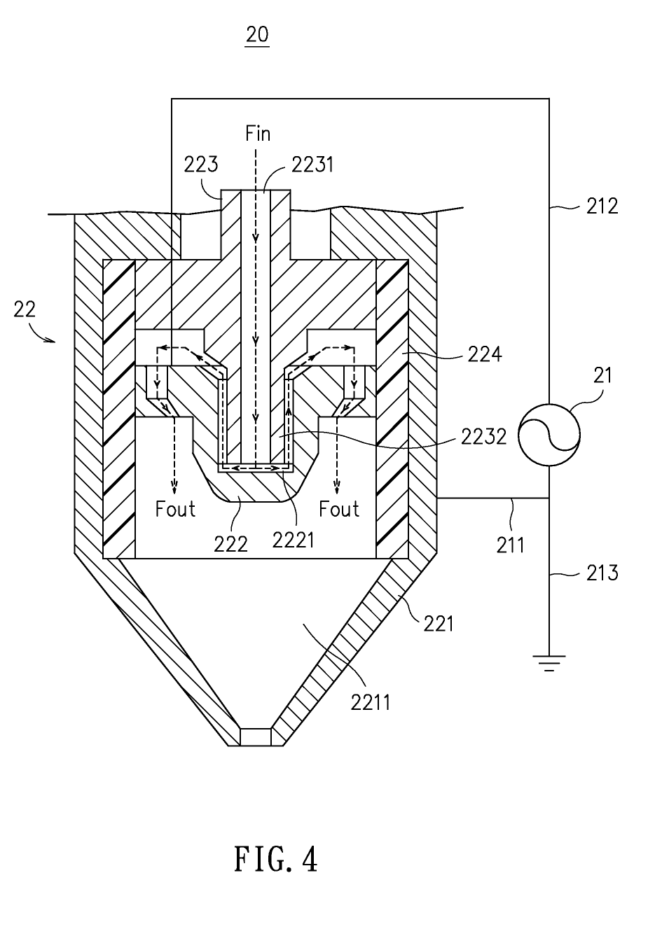

Please refer to FIG. 4, which is a structural diagram of a plasma head and a plasma-discharging device using such a plasma head according to a first embodiment of the present invention. The plasma-discharging device 20 comprises a power supply 21 and a plasma head 22. The power supply 21 provides power and comprises two electrode terminals 211, 212. The bottom electrode terminal 211 is connected to the ground 213. The plasma head 22 comprises an outer electrode 221 and an inner electrode 222. The outer electrode 221 comprises a chamber 2211 formed therein and the inner electrode 222 is disposed inside the chamber 2211. An insulating layer 224 is disposed on the inner sidewall of the outer electrode 211. The outer electrode 221 and the inner electrode 222 are connected respectively to the two electrode terminals 211, 212 of the power supply 21. Generally, the outer electrode 221 is the cathode and the inner electrode 222 is the anode. The outer electrode 221 and the inner electrode 222 are formed of metal with high conductivity and high melting point. Moreover, a tube 223 having an inlet 2231 for introducing the working fluid (the starting point of an arrowed dotted line Fin in FIG. 4) is disposed above the outer electrode 221 and the inner electrode 222. The working fluid can be dry air, oxygen, nitrogen, helium, alkane, alkene or alkyne.

The present invention is characterized in that a path is formed inside the inner electrode 222 to communicate with the inlet 2231. The path communicates with the chamber 2211 in the outer electrode 221 so as to introduce the working fluid into the chamber 2211 by way of the inner electrode 222. In the embodiment shown in FIG. 4, a chamber 2221 is disposed in the inner electrode 222. A flow guiding structure 2232 extending into the chamber 2221 is disposed at the bottom of the tube 223 so that the flow guiding structure 2232 communicates with the chamber 2221. As indicated by the arrowed dotted line in FIG. 4, the working fluid is introduced from the starting point Fin of the path into the chamber 2211 (the end point of an arrowed dotted line Fout in FIG. 4) inside the outer electrode 221 by way of the chamber 2221 in the inner electrode 222.

It is noted that, for conventional plasma discharge, the working fluid is introduced directly into the chamber in the outer electrode to cause plasma discharge. However, in the present invention, a flow guiding structure is disposed to introduce the working fluid into the inner electrode 222 and the chamber 2211 in the outer electrode 221 to cause plasma discharge. The working fluid cools down the inner electrode 222 to prevent wear and contamination due to ion stripping and prolong the lifetime of the inner electrode 222. The previous embodiment is used to exemplify but not to limit the scope of the present invention. The present invention is characterized in that the working fluid is introduced into the inner electrode.

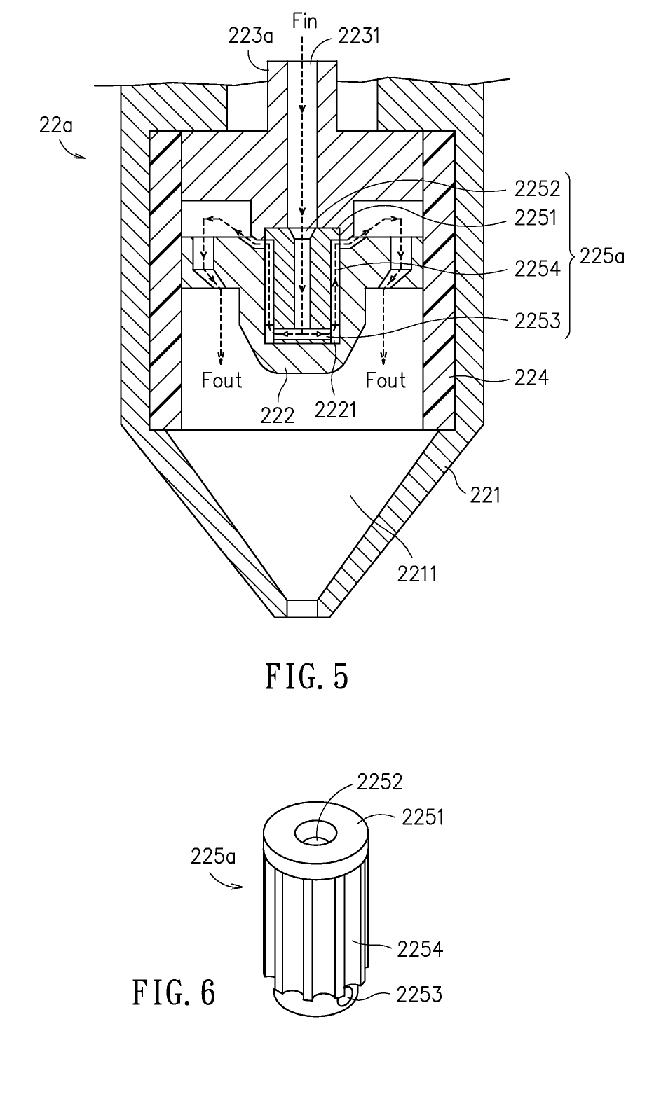

Please refer to FIG. 5, which is a structural diagram of a plasma head according to a second embodiment of the present invention. In FIG. 5, the plasma head 22a comprises an outer electrode 221 and an inner electrode 222. An insulating layer 224 is disposed on the inner sidewall of the outer electrode 211. A tube 223a having an inlet 2231 for introducing the working fluid (the starting point of an arrowed dotted line Fin in FIG. 4) is disposed above the inner electrode 222. A path is formed inside the inner electrode 222 to communicate with the inlet 2231. The path communicates with the chamber 2211 in the outer electrode 221. The afore-mentioned elements are identical to those in the embodiment shown in FIG. 4 and thus are not repeated.

The present embodiment is characterized in that a flow guiding unit 225a is formed between the tube 223a and the inner electrode 222. In other words, the flow guiding structure 2232 in FIG. 4 is modified to become an independent element. FIG. 6 is a 3-dimensional structural diagram of a flow guiding unit 225a in the plasma head according to the second embodiment in FIG. 5. The flow guiding unit 225a comprise a body 2251 having a cooling channel formed therein to comprise a longitudinal channel 2252 and a traverse channel 2253. The longitudinal channel 2252 longitudinally extends a length. The traverse channel 2253 is disposed at the bottom of the longitudinal channel 2252 to transversely pass through the body 2251 and communicate with the bottom of the longitudinal channel 2252. A cooling channel comprising the longitudinal channel 2252 and the traverse channel 2253 is thus formed inside the body 2251. An inlet for introducing the working fluid into the body is provided at the head of the longitudinal channel 2252. An outlet for guiding the working fluid to flow from the body 2251 is provided so that the traverse channel 2253 passes through the body 2251.

Moreover, a flow guiding path is disposed on the outer rim of the body 2251. In the present embodiment, a plurality of fillisters 2254 being parallel are disposed around the outer rim of the body 2251. The bottom ends of the plurality of fillisters 2254 communicate with the traverse channel 2253 of the body 2251. The top ends of the plurality of fillisters 2254 communicate with the chamber 2211 in the outer electrode 221. Therefore, the working fluid flows into the chamber 2211 (the end point of an arrowed dotted line Fout in FIG. 5) in the outer electrode 221 after it flows from the head of the longitudinal channel 2252 into the body 2251 and out of the inner electrode 222 by way of the traverse channel 2253 and the fillisters 2254.

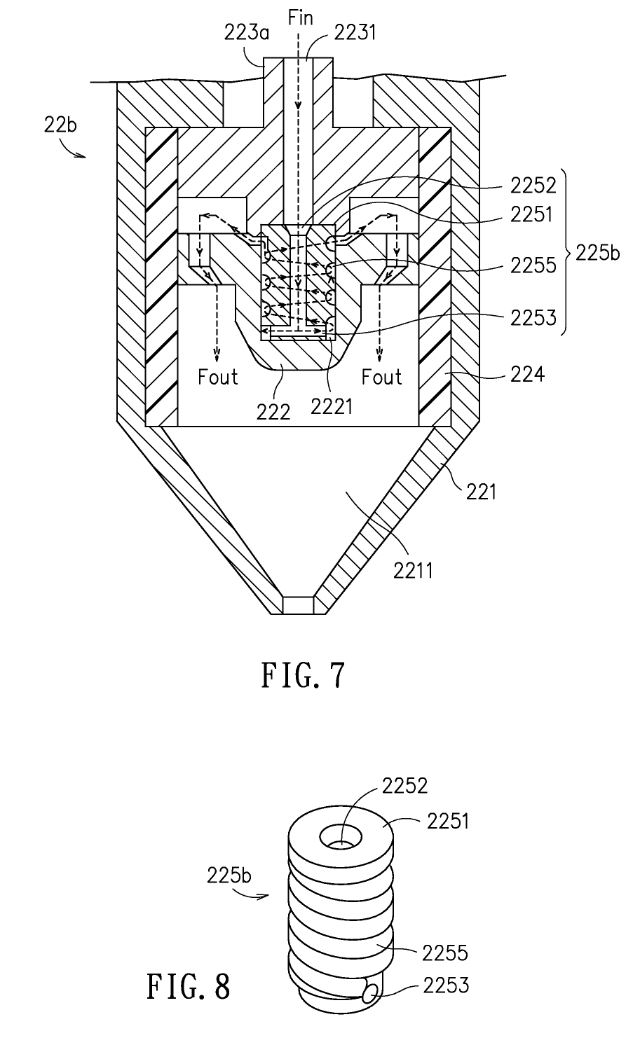

Based on the embodiment described in FIG. 5, FIG. 7 is a structural diagram of a plasma head according to a third embodiment of the present invention. The plasma head 22b comprises an outer electrode 221, an inner electrode 222, a tube 223a, and an insulating layer 224. The tube 223a comprises an inlet 2231 for introducing the working fluid (the starting point of an arrowed dotted line Fin). The inner electrode 222 comprises a chamber 2221. A flow guiding unit 225b is disposed at the bottom of the tube 223a so that the flow guiding unit 225b extends into the chamber 2221.

Referring to FIG. 7 and FIG. 8, the flow guiding unit 225b is based on the flow guiding unit 225a in FIG. 6 to comprise a cooling channel formed therein. The cooling channel comprises a longitudinal channel 2252 and a traverse channel 2253. The traverse channel 2253 is disposed at the bottom of the longitudinal channel 2252 to transversely pass through the body 2251 and communicate with the bottom of the longitudinal channel 2252. The present embodiment is characterized in that a spiral flow guiding path 2255 is disposed on the outer rim of the body 2251. The bottom of the spiral flow guiding path 2255 communicates with the traverse channel 2253 of the body 2251. Accordingly, the working fluid flows into the chamber 2211 (the end point of an arrowed dotted line Fout in FIG. 7) in the outer electrode 221 after it flows from the head of the longitudinal channel 2252 into the body 2251 and out of the inner electrode 222 by way of the traverse channel 2253 and the spiral flow guiding path 2255.

According to the embodiments in FIG. 5 to FIG. 8, the flow guiding structure of the present invention can be designed with different modes as long as it can introduce the working fluid into and out of the inner electrode before the working fluid flows into the chamber in the outer electrode so that the inner electrode can be cooled down. However, the present invention is not limited to the afore-mentioned embodiments. The flow guiding path can be exemplified by the fillisters 2254 in FIG. 6, the spiral flow guiding path 2255 in FIG. 8 or other formats. Since the flow guiding units 225a and 225b are independent elements, they can be replaced without any difficulty.

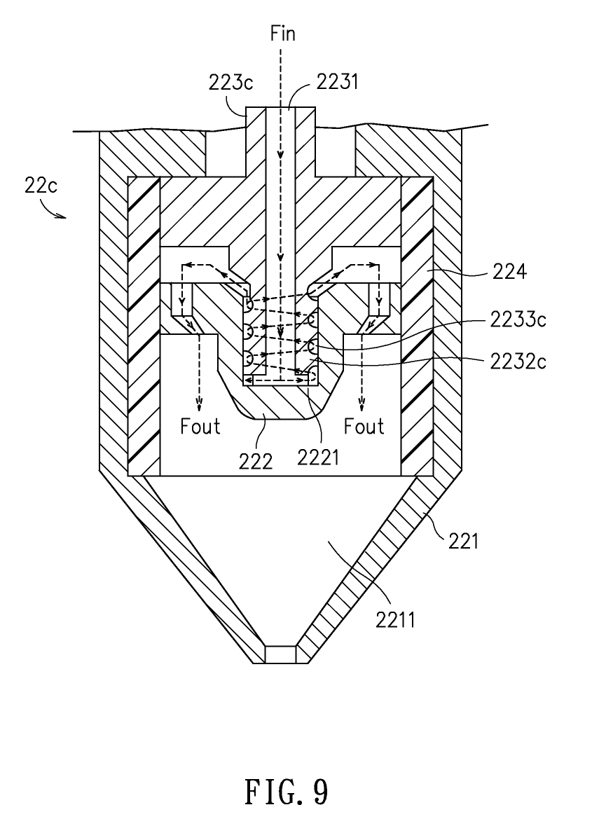

Based on the plasma heads 22a and 22b in FIG. 4 and FIG. 7, FIG. 9 is a structural diagram of a plasma head according to a fourth embodiment of the present invention. In other words, the plasma head 22c comprises the flow guiding unit 225b and the tube 223a in FIG. 8. More particularly, the plasma head 22c comprises an outer electrode 221, an inner electrode 222, a tube 223c and an insulating layer 224. The tube 223c comprises an inlet 2231 for introducing the working fluid (the starting point of an arrowed dotted line Fin). The inner electrode 222 comprises a chamber 2221. A flow guiding unit 2232c is disposed at the bottom of the tube 223c so that the flow guiding unit 2232c extends into the chamber 2221. A spiral flow guiding path 2233c is disposed on the outer rim of the flow guiding structure 2232c. Accordingly, the working fluid flows into the chamber 2211 in the outer electrode 221 after it flows through the chamber 2221 in the inner electrode 222.

In the embodiment in FIG. 9, the flow guiding unit and the tube are combined. Alternatively, the flow guiding unit and the inner electrode can also be combined. These are modifications apparent to persons skilled in the art and thus descriptions thereof are not repeated.

According to the above discussion, it is apparent that the present invention discloses a plasma head and a plasma-discharging device using such a plasma head, the plasma head comprises an inner electrode having a cooling channel disposed therein for introducing a working fluid into the inner electrode as a cooling fluid to effectively reduce the electrode temperature, prevent the inner electrode from consumption, prolong the lifetime of the inner electrode and avoid contamination due to ion stripping.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A plasma head, comprising:
an outer electrode having a chamber formed therein;
an inner electrode, disposed inside the chamber; and
a flow guiding structure, disposed inside the inner electrode and comprising at least an inlet for introducing a working fluid into the inner electrode and at least an outlet being communicated with the chamber of the outer electrode, wherein the flow guiding structure guides the working fluid to flow into the chamber of the outer chamber.

2. The plasma head as recited in claim 1, wherein the flow guiding structure further comprises:
a chamber, disposed inside the inner electrode;
a flow guiding unit, disposed in the chamber inside the inner electrode, comprising:
a body, comprising a cooling channel formed therein to comprise at least an inlet for introducing a working fluid into the body and at least an outlet for guiding the working fluid to flow from the body; and
at least a flow guiding path disposed on the outer rim of the body, one end of the flow guiding path being connected to one end of the cooling channel in the body and another end of the flow guiding path being connected to the chamber of the outer electrode.

3. The plasma head as recited in claim 2, wherein the flow guiding path further comprises a plurality of fillisters being parallel and disposed around the outer rim of the body, the bottom ends of the plurality of fillisters communicating with the outlet of the cooling channel of the body.

4. The plasma head as recited in claim 2, wherein the flow guiding path is spiral.

5. The plasma head as recited in claim 2, wherein the cooling channel of the body comprises:
at least a longitudinal channel, longitudinally extending a length so that the head thereof receives the working fluid; and
at least a traverse channel, transversely passing through the body, the traverse channel being disposed at the bottom of the longitudinal channel and communicating with the bottom of the longitudinal channel, and the traverse channel communicating one end of the flow guiding path.

6. The plasma head as recited in claim 2, further comprising:
a tube, having an inlet for introducing the working fluid, the tube being disposed on the outer electrode and the inner electrode, the tube communicating the body; and
an insulating layer, disposed on the inner sidewall of the outer electrode, the insulating layer and the inner electrode being separated by a distance to form a path communicating with the chamber.

7. The plasma head as recited in claim 6, wherein the flow guiding unit and the tube are integrated.

8. The plasma head as recited in claim 1, wherein the working fluid is dry air, oxygen, nitrogen, argon, helium, alkane, alkene, alkyne or combination thereof.

9. A plasma discharge device, comprising:
a power supply, having two electrode terminals;
a plasma head, comprising:
an outer electrode having a chamber formed therein;
an inner electrode, disposed inside the chamber; and
a flow guiding structure, disposed inside the inner electrode and comprising at least an inlet for introducing a working fluid into the inner electrode and at least an outlet being communicated with the chamber of the outer electrode, wherein the flow guiding structure guides the working fluid to flow into the chamber of the outer chamber.

10. The plasma discharge device as recited in claim 9, wherein the flow guiding structure further comprises:
a chamber, disposed inside the inner electrode;
a flow guiding unit, disposed in the chamber inside the inner electrode, comprising:
a body, comprising a cooling channel formed therein to comprise at least an inlet for introducing a working fluid into the body and at least an outlet for guiding the working fluid to flow from the body; and
at least a flow guiding path disposed on the outer rim of the body, one end of the flow guiding path being connected to one end of the cooling channel in the body and another end of the flow guiding path being connected to the chamber of the outer electrode.

11. The plasma discharge device as recited in claim 10, wherein the flow guiding path further comprises a plurality of fillisters being parallel and disposed around the outer rim of the body, the bottom ends of the plurality of fillisters communicating with the outlet of the cooling channel of the body.

12. The plasma discharge device as recited in claim 10, wherein the flow guiding path is spiral.

13. The plasma discharge device as recited in claim 10, wherein the cooling channel of the body comprises:
at least a longitudinal channel, longitudinally extending a length so that the head thereof receives the working fluid; and
at least a traverse channel, transversely passing through the body, the traverse channel being disposed at the bottom of the longitudinal channel and communicating with the bottom of the longitudinal channel, and the traverse channel communicating one end of the flow guiding path.

14. The plasma discharge device as recited in claim 10, further comprising:
a tube, having an inlet for introducing the working fluid, the tube being disposed on the outer electrode and the inner electrode, the tube communicating the body; and
an insulating layer, disposed on the inner sidewall of the outer electrode, the insulating layer and the inner electrode being separated by a distance to form a path communicating with the chamber.

15. The plasma discharge device as recited in claim 14, wherein the flow guiding unit and the tube are integrated.

16. The plasma discharge device as recited in claim 9, wherein the working fluid is dry air, oxygen, nitrogen, argon, helium, alkane, alkene, alkyne or combination thereof.
